(19) United States
(12) Patent Application Publication
(10) Pub. No.: US 2008/0025784 A1
(43) Pub. Date: Jan. 31, 2008

(54) Multi-marker system for interchangeable exchange of implements and writing utensils

(76) Inventor: Kristopher Joseph Mueller, Asheville, NC (US)

Correspondence Address: JACOBSON HOLMAN PLLC, 400 SEVENTH STREET N.W., SUITE 600, WASHINGTON, DC, 20004, US

(21) Appl. No.: 11/878,681

(22) Filed: Jul. 26, 2007

Related U.S. Application Data
(60) Provisional application No. 60/833,357, filed on Jul. 27, 2006.

(51) Int. Cl. B43K 27/08

(52) U.S. Cl. 401/34

(57) ABSTRACT

A compressible holder for positioning any combination of a plurality of writing utensils in differing orientations. The writing utensils present multi-color, multi-implement usage.

This application is a complete application claiming the benefit of provisional application Ser. No. 60/833,357, filed Jul. 27, 2006.

### FIELD OF THE INVENTION

This invention relates to a multiple writing utensil holder in many shapes and sizes.

### BACKGROUND OF THE INVENTION

There are many uses for writing utensils in every field. Across a wide range of fields from different professions to novelty toys, using writing implements such as pens, pencils, dry erase markers, chalk, crayon sticks, etc. is required.

Some patents describing the use of writing utensils are:

U.S. Pat. No. 6,953,296

U.S. Pat. No. 6,685,373

U.S. Pat. No. 6,554,517

U.S. Pat. No. 6,155,733

U.S. Pat. No. 5,813,787

U.S. Pat. No. 5,971,643

U.S. Pat. No. 5,388,924

U.S. Pat. No. 5,368,404

U.S. Pat. No. 5,306,092

U.S. Pat. No. 5,203,638

U.S. Pat. No. 5,116,153

U.S. Pat. No. 4,580,918

U.S. Pat. No. 3,887,287

U.S. Pat. No. 3,765,780

U.S. Pat. No. 3,750,292

U.S. Pat. No. 3,442,595

U.S. Pat. No. 3,164,906

U.S. Des. Pat. No. D476,362

U.S. Provisional Pat. Appln. 60/560,153

U.S. Patent Publication No. 2003/0016987

### SUMMARY OF THE INVENTION

All writing utensils can be used with the present invention. The design of the present invention also incorporates many additional features to aid in the multiple functions of the present design. A magnet may be used to hold the holder on a magnetic board, a hook may be used to hang the holder, a suction cup may also be used to adhere the holder to a surface, and possibly VELCRO hook and loop fasteners may be used to fasten the holder to a surface. These attachments may be removably mounted in the place where a marker is held.

The holder of the present invention presents an interchangeable unit to use different color or style writing utensils in any desired combination, as well as for holding a hanging attachment.

The holder of the present invention may be of a compressible form such that it is easily gripped by individuals that have arthritis. The compressible material may be of a rubber or rubber-like composition, such as is encountered with a pink, solid composition, spongy ball. It is envisioned that the compressible material may include a dense rubber.

In addition, the compressible material of the holder facilities a firm grip and a deformation of the holder to the shape of the fingers grasping the holder. Thereby, a firm grip is achieved with enhanced ergonomic features.

The shape of the holder may accomplish different functions such as being gripped by only or at least a thumb and a single finger. Corresponding indentations may be formed in the holder to accommodate the use of only two fingers.

It is possible that the writing utensils could be permanently or removably secured in the holder. In the removably secured embodiment, different arrangements of colors are possible.

In an embodiment including multiple writing utensils, it is possible, by the angling of the orientation of the holder with respect to a writing surface, to increase the number of markers being applied to the writing surface. Two, and possibly three, writing utensils may simultaneously provide a multi-color, multi-line effect on a writing surface.

In an alternate embodiment, a single utensil may be held at one end of a spherically shaped holder. At an opposite side of the holder, the sphere may be flat for maintaining an upright positioning of the utensil in the holder on a flat desk top.

A primary object is to create a perpendicular axis from more than one intersecting plane passing through a holder of writing utensils. The planes are formed by the writing utensils, but it is not necessary that the planes be perpendicular. The additional utensils can be simply attached to the same holder having at least one set of perpendicular planes passing through the holder.

Another object is to create a writing utensil tool for proficiency of task and in other embodiments a fun source of multi-color and multi-implement use.

An additional object is to create a system for effective use of an efficient product that can incorporate other tools additional to writing utensils such as erasers, magnets to hold the holder to a magnetic board, a hook for hanging the holder, a suction cup for hanging the holder and VELCRO hook and loop fasteners to fasten the holder to an object.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the invention disclosed herein, and are for illustrative purposes only. Other embodiments that are substantially similar can use other components that have a different appearance.

FIG. 1 is a side view of a first embodiment of the present invention being held by a user.

FIG. 2 is a front view of the use of the first embodiment of the present invention by application to a writing surface.

FIG. 3 is a top plan view of the first embodiment of the present invention.

FIG. 4 is a sectional view taken along line 4-4 as shown in FIG. 3.

FIG. 5 is a side view of an alternate embodiment of the present invention illustrating a spherical holder having a flat surface for positioning the holder on a flat support surface.

FIG. 6 is a sectional view taken along line 6-6 of FIG. 5.

FIG. 7 is a top plan view of another alternate embodiment of the present invention illustrating a three writing utensil holder.

FIG. 8 is a sectional view taken along line 8-8 as shown in FIG. 7.

FIG. 9 is a top plan view of another alternate embodiment of the present invention illustrating a six writing utensil holder.

FIG. 10 is a sectional view taken along line 10-10 as shown in FIG. 9.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

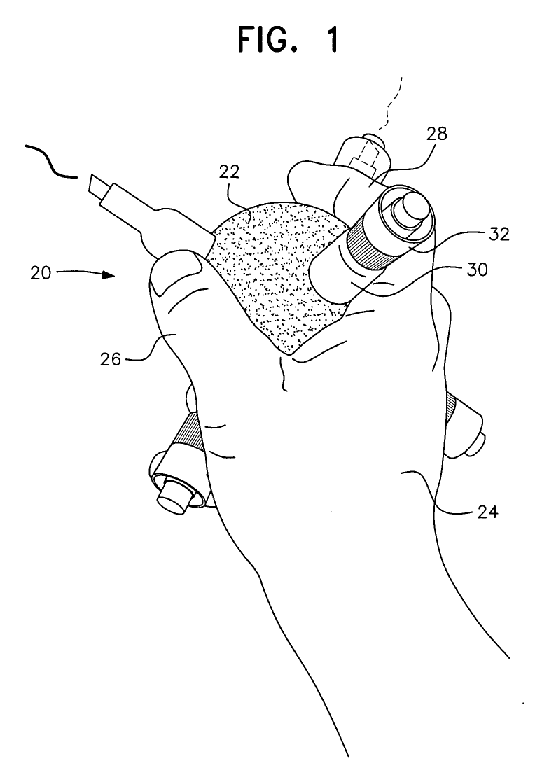

With reference to the drawings, in general, and to FIGS. 1-4, in particular, a multi-marker system for interchangeable exchange of implements and writing utensils is generally designated as 20. With reference to its orientation in FIG. 1, the multi-marker system includes a holder 22 formed of a spherical spongy composition. As shown in FIG. 1, the multi-marker system is held in the hand 24 of the user with at least the thumb 26 and index finger 28 grabbing the holder 22 in a comfortable, ergonomic manner.

In the embodiment of FIGS. 1-4, six dry erase markers 30 having caps 32 are held in recesses 34 for removably mounting the markers 30 in the holder 22. The diameter of the holder is approximately 2½ inches. The compressibility of the holder 22 allows the insertion and removal of the markers in the holder. Alternatively, the markers could be permanently secured in the holder. However, the changing of the colors of the markers 30 and replacement of a color when the liquid material of the marker is depleted, form important parts of the present invention.

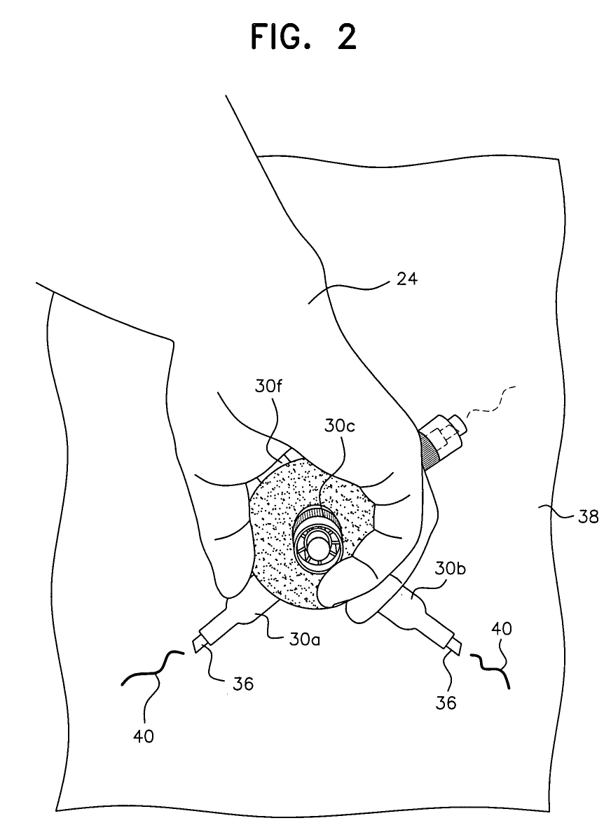

As shown in FIG. 2, when caps are removed from the markers 30a and 30b, the felt tips 36 are exposed for writing on a writing surface 38. In the position held, shown in FIG. 2, it is possible to draw two lines 40 on the writing material, simultaneously, as the holder is moved across the writing surface. It is also possible, with the arrangement of six markers in the embodiments of FIGS. 1-4, to have a third marker 30d, blocked from view by the hand 24 of the user, to similarly contact the writing surface 38 and draw a third line on the writing surface simultaneously with markers 30a and 30b.

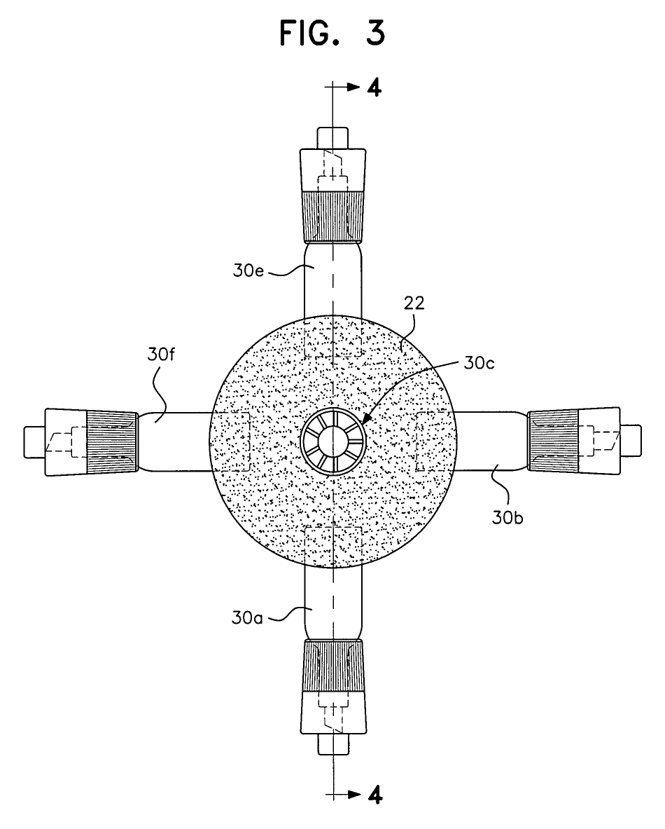

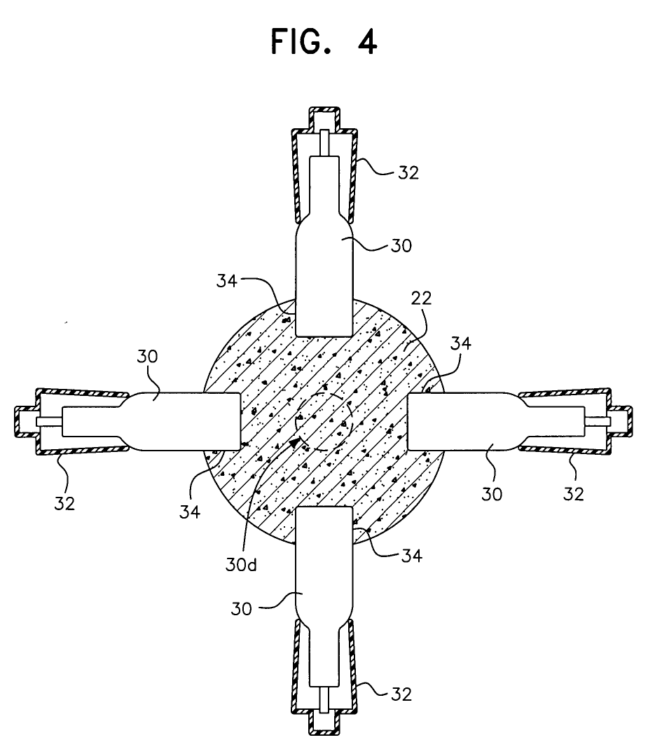

As shown in FIG. 3, markers 30a, 30b, 30e and 30f lie in a single plane extending from the holder 22, having an angle of separation of 90° between each two adjacent markers. Markers 30a and 30e are diametrically opposed from each other, as are markers 30b and 30f. Similarly, markers 30c and 30d, shown in dotted lines in FIG. 4, project 90° with respect to markers 30a, b, e and f, and markers 30c and 30d extend diametrically opposed to each other. Therefore, in FIG. 2, markers 30a, 30b and 30c can simultaneously draw three parallel lines on the writing surface 38. Similarly, by angling of the holder 22, only two lines or only a single line may be drawn on the writing surface 38.

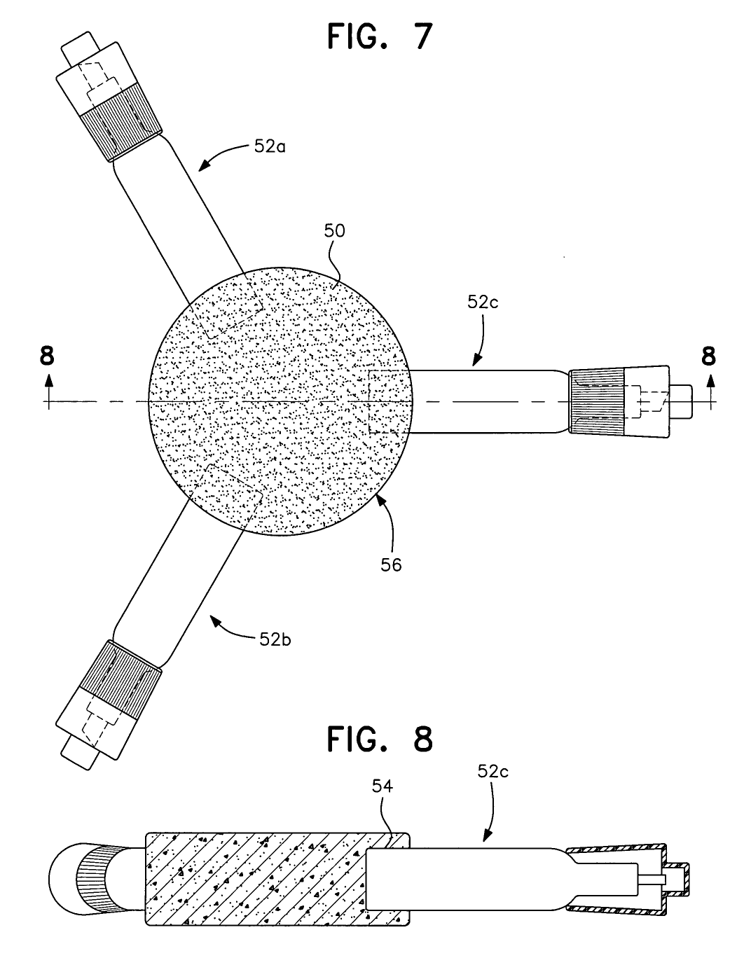

With respect to the embodiment shown in FIGS. 7 and 8, the holder 50 is in the form of a disk having a diameter of approximately 1½ inches and a height of approximately one inch. The holder is formed of compressible spongy material and, in this embodiment, holds three markers, 52a, 52b and 52c. As shown in FIG. 8, the marker 52c is releasably held in a recess 54 in a side wall 56 of the holder. In this embodiment, two markers may simultaneously contact a writing surface, whereas it is possible that a single marker contact the writing surface.

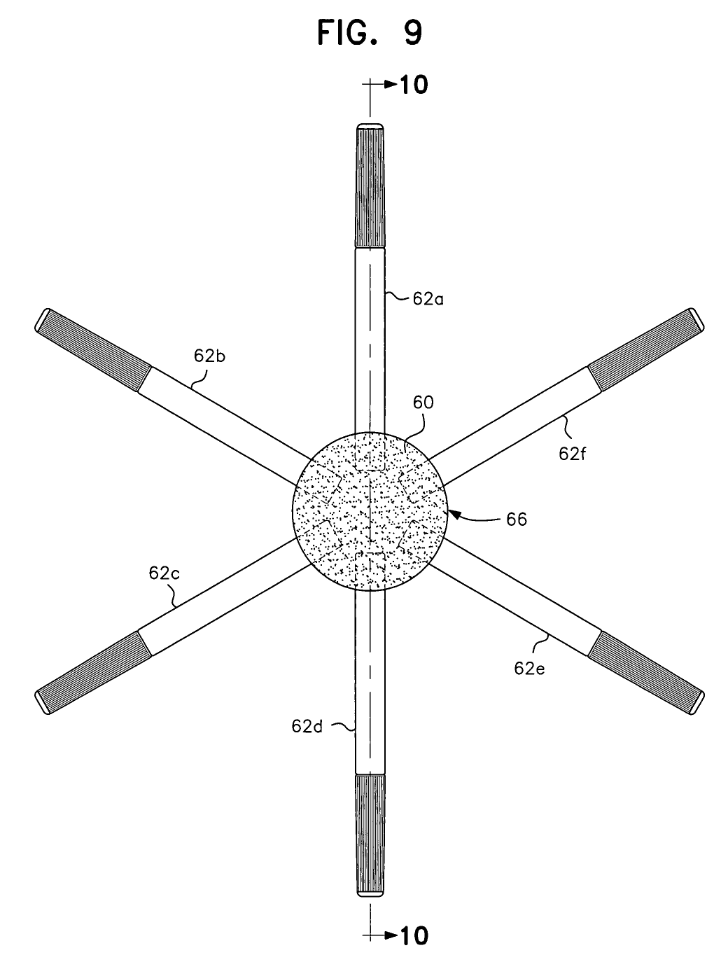

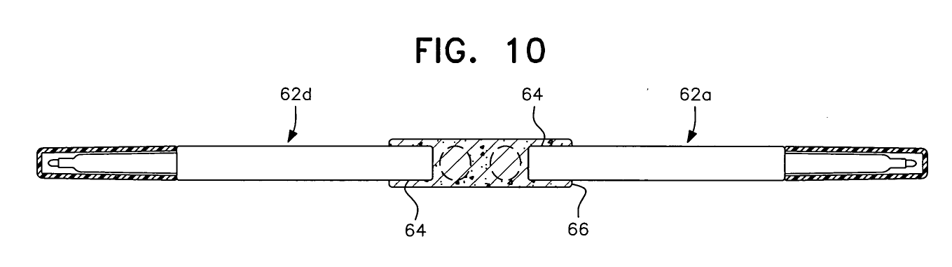

Similarly, in FIGS. 9 and 10, a holder 60 in the form of a disk having a diameter of approximately 1½ inches and a height of approximately ¾ inch holds six markers, 62a, 62b, 2c, 62d, 62e and 62f.

As shown in FIG. 10, the markers are releasably held in a recess 64 formed in the side wall 66 of the holder. In this embodiment, two markers may simultaneously mark a writing surface.

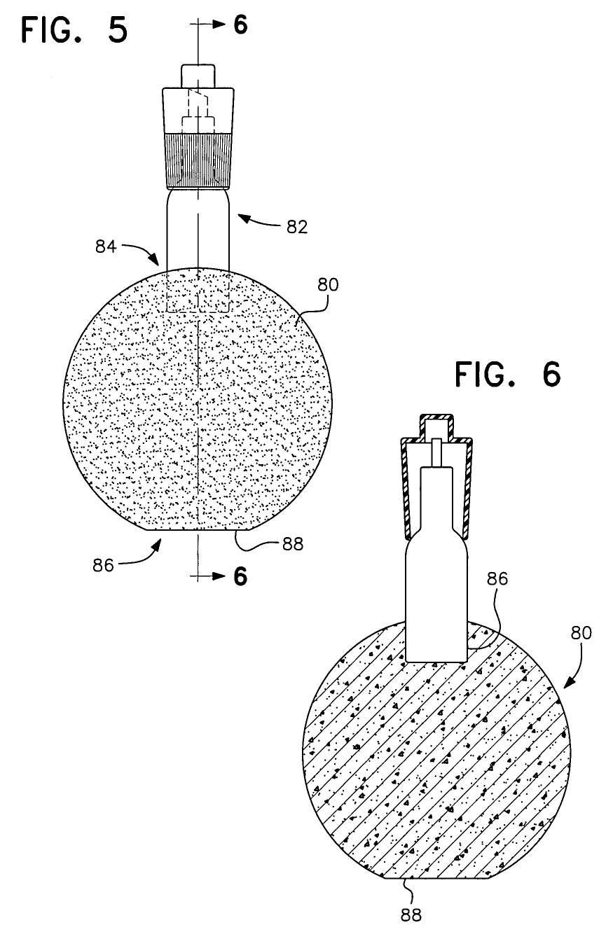

Turning now to the embodiment of FIGS. 5 and 6, a compressible spongy holder 80 is formed in a spherical configuration. A single marker 82 projects from portion 84 and is removably held in a recess 86 of the holder 80. In a diametrically opposite surface area 86, a flat surface 88 is formed. By placement of the flat surface 88 on a support surface, the marker 82 is positioned perpendicular to the support surface. There is also envisioned as being within the scope of the present invention that the marker 82 be positioned at an angle with respect to the position shown in FIG. 5, such that the holder holds the marker in a position projecting towards the user. The holder 80 can be compressibly held by the hand of a user to mark a writing surface.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A writing implement comprising
a holder for holding a plurality of writing utensils at divergent angles, said holder being compressible by manual pressure.

2. The writing implement as claimed in claim 1, wherein said holder is spherical.

3. The writing implement as claimed in claim 1, wherein said holder is disk shaped.

4. The writing implement as claimed in claim 1, wherein said holder includes recesses for receipt of the plurality of writing utensils.

5. The writing implement as claimed in claim 4, wherein said recesses are cylindrical.

6. The writing implement as claimed in claim 5, wherein said recesses are equally spaced from each other.

7. The writing implement as claimed in claim 5, wherein said recesses lie in a single plane.

8. The writing implement as claimed in claim 5, wherein said recesses form intersecting planes.

9. The writing implement as claimed in claim 5, wherein some of the recesses form intersecting planes and some of the recesses lie in a single plane.

10. The writing implement as claimed in claim 4, wherein said recesses removably hold the writing utensils in the holder.

11. A writing implement comprising
a compressible writing utensil holder,
a recess formed in the holder for receipt of a writing utensil, and
an area of said holder being flat for positioning the writing utensil on a flat surface in a desired orientation.

12. The writing implement as claimed in claim 11, wherein said area is opposite to said recess.

13. The writing implement as claimed in claim 12, wherein said recess removably holds said writing utensil in said holder.

14. The writing implement as claimed in claim 11, wherein said holder is spherical.
